(19) United States
(12) Patent Application Publication
(10) Pub. No.: US 2015/0032379 A1
(43) Pub. Date: Jan. 29, 2015

(54) ATTENUATION OF MULTIPLE REFLECTIONS

(71) Applicant: WESTERNGECO L.L.C., HOUSTON, TX (US)

(72) Inventors: ALLAN JAMES CAMPBELL, Katy, TX (US); JITENDRA SUDESHKUMAR GULATI, Houston, TX (US)

(21) Appl. No.: 14/202,948

(22) Filed: Mar. 10, 2014

Related U.S. Application Data
(60) Provisional application No. 61/780,228, filed on Mar. 13, 2013.

(51) Int. Cl. G01V 1/28; G01V 1/40; G01V 1/30

(52) U.S. Cl. CPC G01V 1/282; G01V 1/306; G01V 1/40; G01V 2210/624; G01V 2210/67; G01V 2210/161
USPC 702/14

(57) ABSTRACT

A method can include receiving an inside stack and an outside stack; generating a multiple reflections model based at least in part on the inside stack and the outside stack; receiving multidimensional seismic data that includes representations of primary reflections and multiple reflections; and generating processed multidimensional seismic data by applying the multiple reflections model to the multidimensional seismic data. Various other apparatuses, systems, methods, etc., are also disclosed.

### CROSS-REFERENCE TO RELATED APPLICATION

This application claims the benefit of U.S. Provisional Patent Application Ser. No. 61/780,228 filed Mar. 13, 2013, which is incorporated herein by reference in its entirety.

### BACKGROUND

Reflection seismology finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Various techniques described herein pertain to processing of data such as, for example, seismic data.

### SUMMARY

In accordance with some embodiments, a method is performed that includes: receiving an inside stack and an outside stack; generating a multiple reflections model based at least in part on the inside stack and the outside stack; receiving multidimensional seismic data that comprises representations of primary reflections and multiple reflections; and generating processed multidimensional seismic data by applying the multiple reflections model to the multidimensional seismic data.

In accordance with some embodiments, a system is provided that includes a processor; memory accessible by the processor; one or more modules stored in the memory and that include processor-executable instructions to instruct the system to: access a multiple reflections model; receive multidimensional seismic data that represents primary reflections and multiple reflections; and apply the multiple reflections model to at least a portion of the multidimensional seismic data to attenuate the multidimensional seismic data that represents the multiple reflections.

In some embodiments, an aspect includes a multiple reflections model that includes a one-dimensional multiple reflections model.

In some embodiments, an aspect includes an inside stack that includes representations of primary reflections and multiple reflections and an outside stack that includes representations of multiple reflections.

In some embodiments, an aspect involves generating a multiple reflections model by, at least in part, adaptively subtracting an outside stack from an inside stack or includes instructions to instruct a system to generate a multiple reflections model by, at least in part, adaptively subtracting an outside stack from an inside stack.

In some embodiments, an aspect involves applying a multiple reflections model by, at least in part, adaptively subtracting at least a portion of representations of multiple reflections from at least a portion of multidimensional seismic data or includes instructions to instruct a system to apply a multiple reflections model by, at least in part, adaptively subtracting at least a portion of representations of multiple reflections from at least a portion of multidimensional seismic data.

In some embodiments, an aspect involves deconvolving seismic data to generate an inside stack and an outside stack or includes instructions to instruct a system to deconvolve seismic data to generate an inside stack and an outside stack.

In some embodiments, an aspect includes seismic data that includes vertical seismic profile (VSP) data.

In some embodiments, an aspect includes seismic data that includes zero-offset vertical seismic profile (ZVSP) data.

In some embodiments, an aspect involves generating an inside stack and an outside stack from surface seismic data or includes instructions to instruct a system to generate an inside stack and an outside stack from surface seismic data.

In some embodiments, an aspect involves generating an inside stack using near-offset surface seismic image traces and generating an outside stack using mid-to-far offset surface seismic image traces or includes instructions to instruct a system to generate an inside stack using near-offset surface seismic image traces and generate an outside stack using mid-to-far offset surface seismic image traces.

In some embodiments, an aspect involves identifying representations of an interbed boundary in processed multidimensional seismic data or includes instructions to instruct a system to identify representations of an interbed boundary in processed multidimensional seismic data.

In some embodiments, an aspect includes an interbed boundary that corresponds to a boundary of a reservoir.

In some embodiments, an aspect includes instructions to instruct a system to: receive an inside stack and an outside stack; and generate multiple reflections model based at least in part on the inside stack and the outside stack.

In some embodiments, an aspect includes instructions to instruct a system to: receive seismic data; deconvolve the seismic data; and generate an inside stack and an outside stack based at least in part on deconvolution of the seismic data.

In some embodiments, an aspect includes instructions to instruct a system to adjust one or more parameters of a field operation.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a geologic environment and an example of a technique;

FIG. 2 illustrates examples of multiple reflections and examples of techniques;

FIG. 3 illustrates examples of survey techniques;

FIG. 4 illustrates an example of a survey technique;

FIG. 5 illustrates an example of a method;

FIG. 6 illustrates examples of data and processed data;

FIG. 7 illustrates examples of data and processed data;

FIG. 8 illustrates an example of a method and an example of a system;

FIG. 9 illustrates an example of a field operation and an example of a method; and

FIG. 10 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

As mentioned, reflection seismology finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz or optionally less that 1 Hz and/or optionally more than 100 Hz). Seismic data may be processed and interpreted, for example, to understand better composition, fluid content, extent and geometry of subsurface rocks.

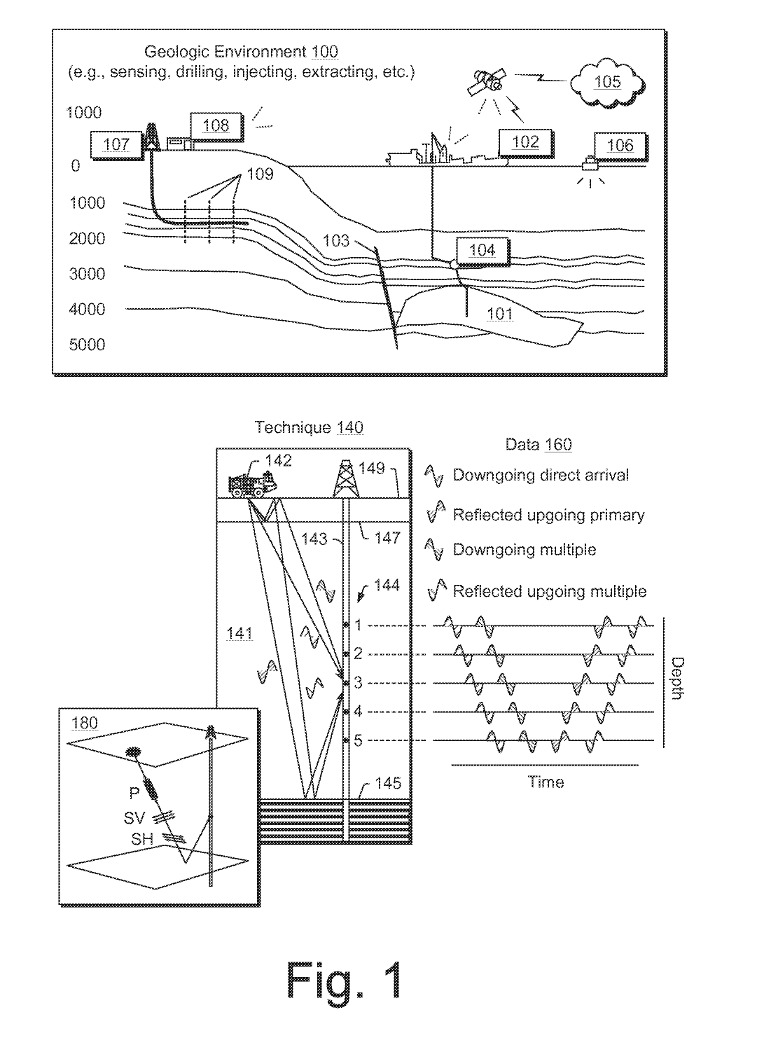

FIG. 1 shows an example of a geologic environment 100 (e.g., an environment that includes a sedimentary basin, a reservoir 101, a fault 103, one or more fractures 109, etc.) and an example of an acquisition technique 140 to acquire seismic data. As an example, a system may process data acquired by the technique 140, for example, to allow for direct or indirect management of sensing, drilling, injecting, extracting, etc., with respect to the geologic environment 100. In turn, further information about the geologic environment 100 may become available as feedback (e.g., optionally as input to the system). As an example, an operation may pertain to a reservoir that exists in the geologic environment 100 such as, for example, the reservoir 101. As an example, a technique may provide information (e.g., as an output) that may specifies one or more location coordinate of a feature in a geologic environment, one or more characteristics of a feature in a geologic environment, etc.

As an example, a system may include features of a commercially available simulation framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of simulating a geologic environment, decision making, operational control, etc.).

As an example, a system may include add-ons or plug-ins that operate according to specifications of a framework environment. For example, a commercially available framework environment marketed as the OCEAN® framework environment (Schlumberger Limited, Houston, Tex.) allows for integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

In the example of FIG. 1, the geologic environment 100 may include layers (e.g., stratification) that include the reservoir 101 and that may be intersected by a fault 103 (see also, e.g., the one or more fractures 109, which may intersect a reservoir). As an example, a geologic environment may be or include an offshore geologic environment, a seabed geologic environment, an ocean bed geologic environment, etc.

As an example, the geologic environment 100 may be outfitted with any of a variety of sensors, detectors, actuators, etc. For example, equipment 102 may include communication circuitry to receive and to transmit information with respect to one or more networks 105. Such information may include information associated with downhole equipment 104, which may be equipment to acquire information, to assist with resource recovery, etc. Other equipment 106 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 105 that may be configured for communications, noting that the satellite may additionally or alternatively include circuitry for imagery (e.g., spatial, spectral, temporal, radiometric, etc.).

FIG. 1 also shows the geologic environment 100 as optionally including equipment 107 and 108 associated with a well that includes a substantially horizontal portion that may intersect with one or more of the one or more fractures 109. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop the reservoir (e.g., via fracturing, injecting, extracting, etc.). As an example, the equipment 107 and/or 108 may include components, a system, systems, etc. for fracturing, seismic sensing, analysis of seismic data, assessment of one or more fractures, etc.

As an example, a system may be used to perform one or more workflows. A workflow may be a process that includes a number of worksteps. A workstep may operate on data, for example, to create new data, to update existing data, etc. As an example, a system may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.). As an example, a workflow may include rendering information to a display (e.g., a display device). As an example, a workflow may include receiving instructions to interact with rendered information, for example, to process information and optionally render processed information. As an example, a workflow may include transmitting information that may control, adjust, initiate, etc. one or more operations of equipment associated with a geologic environment (e.g., in the environment, above the environment, etc.).

In FIG. 1, the technique 140 may be implemented with respect to a geologic environment 141. As shown, an energy source (e.g., a transmitter) 142 may emit energy where the energy travels as waves that interact with the geologic environment 141. As an example, the geologic environment 141 may include a bore 143 where one or more sensors (e.g., receivers) 144 may be positioned in the bore 143. As an example, energy emitted by the energy source 142 may interact with a layer (e.g., a structure, an interface, etc.) 145 in the geologic environment 141 such that a portion of the energy is reflected, which may then be sensed by one or more of the sensors 144. Such energy may be reflected as an upgoing primary wave (e.g., or “primary” or “singly” reflected wave). As an example, a portion of emitted energy may be reflected by more than one structure in the geologic environment and referred to as a multiple reflected wave (e.g., or “multiple”). For example, the geologic environment 141 is shown as including a layer 147 that resides below a surface layer 149. Given such an environment and arrangement of the source 142 and the one or more sensors 144, energy may be sensed as being associated with particular types of waves.

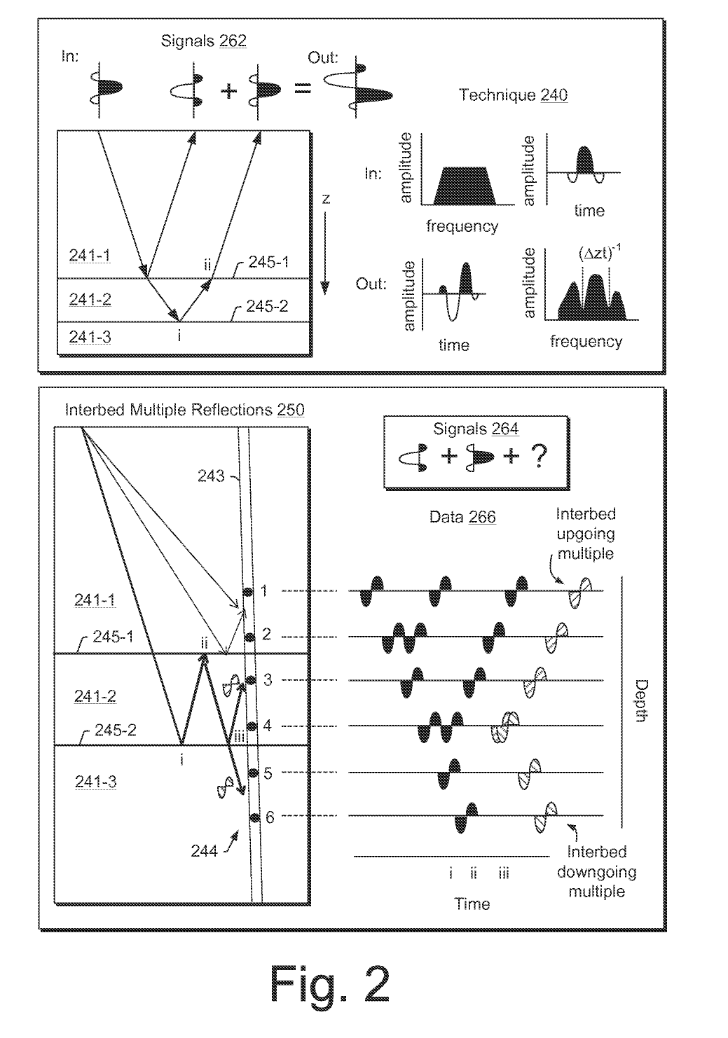

As an example, a “multiple” may refer to multiply reflected seismic energy or, for example, an event in seismic data that has incurred more than one reflection in its travel path. As an example, depending on a time delay from a primary event with which a multiple may be associated, a multiple may be characterized as a short-path or a peg-leg, for example, which may imply that a multiple may interfere with a primary reflection, or long-path, for example, where a multiple may appear as a separate event. As an example, seismic data may include evidence of an interbed multiple from bed interfaces (see also, e.g., FIG. 2), evidence of a multiple from a water interface (e.g., an interface of a base of water and rock or sediment beneath it) or evidence of a multiple from an air-water interface, etc.

As shown in FIG. 1, acquired data 160 can include data associated with downgoing direct arrival waves, reflected upgoing primary waves, downgoing multiple reflected waves and reflected upgoing multiple reflected waves. The acquired data 160 is also shown along a time axis and a depth axis. As indicated, in a manner dependent at least in part on characteristics of media in the geologic environment 141, waves travel at velocities over distances such that relationships may exist between time and space. Thus, time information, as associated with sensed energy, may allow for understanding spatial relations of layers, interfaces, structures, etc. in a geologic environment.

FIG. 1 also shows various types of waves as including P, SV an SH waves. As an example, a P-wave may be an elastic body wave or sound wave in which particles oscillate in the direction the wave propagates. As an example, P-waves incident on an interface (e.g., at other than normal incidence, etc.) may produce reflected and transmitted S-waves (e.g., “converted” waves). As an example, an S-wave or shear wave may be an elastic body wave, for example, in which particles oscillate perpendicular to the direction in which the wave propagates. S-waves may be generated by a seismic energy sources (e.g., other than an air gun). As an example, S-waves may be converted to P-waves. S-waves tend to travel more slowly than P-waves and do not travel through fluids that do not support shear. In general, recording of S-waves involves use of one or more receivers operatively coupled to earth (e.g., capable of receiving shear forces with respect to time). As an example, interpretation of S-waves may allow for determination of rock properties such as fracture density and orientation, Poisson's ratio and rock type, for example, by crossplotting P-wave and S-wave velocities, and/or by other techniques.

As an example of parameters that may characterize anisotropy of media (e.g., seismic anisotropy), consider the Thomsen parameters ε, δ and γ. The Thomsen parameter δ describes depth mismatch between logs (e.g., actual depth) and seismic depth. As to the Thomsen parameter ε, it describes a difference between vertical and horizontal compressional waves (e.g., P or P-wave or quasi compressional wave qP or qP-wave). As to the Thomsen parameter γ, it describes a difference between horizontally polarized and vertically polarized shear waves (e.g., horizontal shear wave SH or SH-wave and vertical shear wave SV or SV-wave or quasi vertical shear wave qSV or qSV-wave). Thus, the Thomsen parameters ε and γ may be estimated from wave data while estimation of the Thomsen parameter δ may involve access to additional information.

As an example, seismic data may be acquired for a region in the form of traces. In the example of FIG. 1, the technique 140 may include the source 142 for emitting energy where portions of such energy (e.g., directly and/or reflected) may be received via the one or more sensors 144. As an example, energy received may be discretized by an analog-to-digital converter that operates at a sampling rate. For example, acquisition equipment may convert energy signals sensed by a sensor to digital samples at a rate of one sample per approximately 4 ms. Given a speed of sound in a medium or media, a sample rate may be converted to an approximate distance. For example, the speed of sound in rock may be of the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing example is divided by two (e.g., to account for reflection), for a vertically aligned source and sensor, the deepest boundary depth may be estimated to be about 10 km (e.g., assuming a speed of sound of about 5 km per second).

FIG. 2 shows an example of a technique 240, examples of signals 262 associated with the technique 240, examples of interbed multiple reflections 250 and examples of signals 264 and data 266 associated with the interbed multiple reflections 250. As an example, the technique 240 may include emitting energy with respect to time where the energy may be represented in a frequency domain, for example, as a band of frequencies. In such an example, the emitted energy may be a wavelet and, for example, referred to as a source wavelet which has a corresponding frequency spectrum (e.g., per a Fourier transform of the wavelet).

As an example, a geologic environment may include layers 241-1, 241-2 and 241-3 where an interface 245-1 exists between the layers 241-1 and 241-2 and where an interface 245-2 exists between the layers 241-2 and 241-3. As illustrated in FIG. 2, a wavelet may be first transmitted downward in the layer 241-1; be, in part, reflected upward by the interface 245-1 and transmitted upward in the layer 241-1; be, in part, transmitted through the interface 245-1 and transmitted downward in the layer 241-2; be, in part, reflected upward by the interface 245-2 (see, e.g., “i”) and transmitted upward in the layer 241-2; and be, in part, transmitted through the interface 245-1 (see, e.g., “ii”) and again transmitted in the layer 241-1. In such an example, signals (see, e.g., the signals 262) may be received as a result of wavelet reflection from the interface 245-1 and as a result of wavelet reflection from the interface 245-2. These signals may be shifted in time and in polarity such that addition of these signals results in a waveform that may be analyzed to derive some information as to one or more characteristics of the layer 241-2 (e.g., and/or one or more of the interfaces 245-1 and 245-2). For example, a Fourier transform of signals may provide information in a frequency domain that can be used to estimate a temporal thickness (e.g., Δzt) of the layer 241-2 (e.g., as related to acoustic impedance, reflectivity, etc.).

As to the data 266, as an example, they illustrate further transmissions of emitted energy, including transmissions associated with the interbed multiple reflections 250. For example, while the technique 240 is illustrated with respect to interface related events i and ii, the data 266 further account for additional interface related events, denoted iii, that stem from the event ii. Specifically, as shown in FIG. 2, energy is reflected downward by the interface 245-1 where a portion of that energy is transmitted through the interface 245-2 as an interbed downgoing multiple and where another portion of that energy is reflected upward by the interface 245-2 as an interbed upgoing multiple. These portions of energy may be received by one or more receivers 244 (e.g., disposed in a well 243) as signals. These signals may be summed with other signals, for example, as explained with respect to the technique 240. For example, such interbed multiple signals may be received by one or more receivers over a period of time in a manner that acts to “sum” their amplitudes with amplitudes of other signals (see, e.g., illustration of signals 262 where interbed multiple signals are represented by a question mark “?”). In such an example, the additional interbed signals may interfere with an analysis that aims to determine one or more characteristics of the layer 241-2 (e.g., and/or one or more of the interfaces 245-1 and 245-2). For example, interbed multiple signals may interfere with identification of a layer, an interface, interfaces, etc. (e.g., consider an analysis that determines temporal thickness of a layer, etc.).

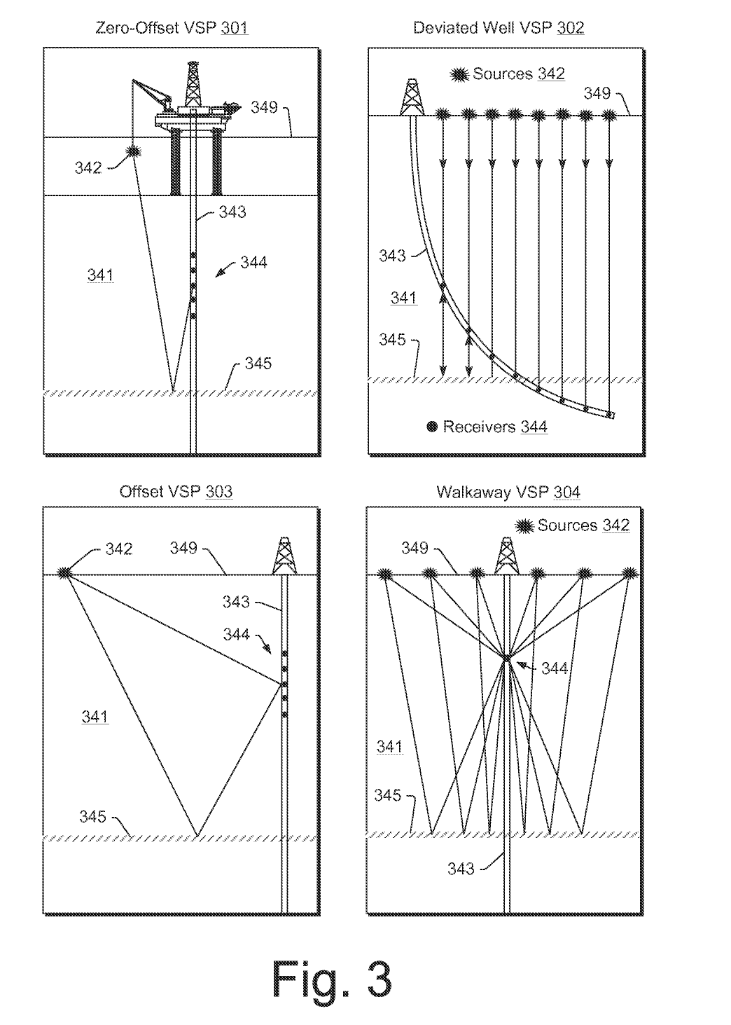

FIG. 3 shows some examples of data acquisition techniques or “surveys” that include a zero-offset vertical seismic profile (VSP) technique 301, a deviated well vertical seismic profile technique 302, an offset vertical seismic profile technique 303 and a walkaway vertical seismic profile technique 304. In each of the examples, a geologic environment 341 with a surface 349 is shown along with at least one energy source (e.g., a transmitter) 342 that may emit energy where the energy travels as waves that interact with the geologic environment 341. As an example, the geologic environment 341 may include a bore 343 where one or more sensors (e.g., receivers) 344 may be positioned in the bore 343. As an example, energy emitted by the energy source 342 may interact with a layer (e.g., a structure, an interface, etc.) 345 in the geologic environment 341 such that a portion of the energy is reflected, which may then be sensed by at least one of the one or more of the sensors 344. Such energy may be reflected as an upgoing primary wave (e.g., or “primary” or “singly” reflected wave). As an example, a portion of emitted energy may be reflected by more than one structure in the geologic environment and referred to as a multiple reflected wave. As an example, a multiple reflected wave may be or include an interbed multiple reflected wave (see, e.g., interbed multiple reflections 250 of FIG. 2).

As to the example techniques 301, 302, 303 and 304, these are described briefly below, for example, with some comparisons. As to the technique 301, given the acquisition geometry, with no substantial offset between the source 342 and bore 343, a zero-offset VSP may be acquired. In such an example, seismic waves travel substantially vertically down to a reflector (e.g., the layer 345) and up to the receiver 344, which may be a receiver array. As to the technique 302, this may be another so-called normal-incidence or vertical-incidence technique where a VSP may be acquired in, for example, a deviated bore 243 with one or more of the source 342 positioned substantially vertically above individual receivers 344 (e.g., individual receiver shuttles). The technique 302 may be referred to as a deviated-well or a walkabove VSP. As to the offset VSP technique 303, in the example of FIG. 3, an array of seismic receivers 344 may be clamped in a bore 343 and a seismic source 342 may be placed a distance away. In such an example, non-vertical incidence can give rise to P- to S-wave conversion. As to the walkaway VSP technique 304, as an example, a seismic source 342 may be activated at numerous positions along a line on the surface 349. The techniques 301, 302, 303 and 304 may be implemented as onshore and/or offshore surveys.

As may be appreciated from the examples of FIG. 3, a borehole seismic survey may be categorized by a survey geometry, which may be determined by source offset, borehole trajectory and receiver array depth. For example, a survey geometry may determine dip range of interfaces and the subsurface volume that may be imaged. As an example, a survey may define a region, for example, a region about a borehole (e.g., via one or more dimensions that may be defined with respect to the borehole). As an example, positions of equipment may define, at least in part, a survey geometry (e.g., and a region associated with a borehole, wellbore, etc.).

Again, as to a zero-offset VSP, a set-up may include a borehole seismic receiver array and a near-borehole seismic source. Such an approach may, where formation dips do not exceed some limit, acquire reflections from a relatively narrow window around the borehole. An output from a zero-offset VSP may be a corridor stack. As an example, a corridor stack may be created by summing VSP signals that immediately follow first arrivals into a single seismic trace. In such an example, the trace may be duplicated several times for clarity and comparison with surface seismic images. As an example, processing may yield velocities of formations at different depths, which may, for example, be tied to well log properties and interpreted for detection and prediction of zones (e.g., overpressured zones, etc.). As an example, a velocity model may be used to generate “synthetics,” for example, as part of a process to identify multiples in surface seismic processing.

As to a zero-offset VSP (e.g., a deviated-well, walkabove, or vertical-incidence VSP technique), a set-up may be configured to help assure that a source remains substantially above a receiver or receivers deployed in a deviated or horizontal wellbore. Such a survey may acquire a 2D image of a region below the borehole. As an example, in addition to formation velocities and an image for correlation with surface seismic data, a walkabove VSP may provide lateral coverage and information as to fault and dip identification beneath a well.

As to an offset VSP, a set-up may include a source placed at a horizontal distance, or offset, from a wellbore. Such an approach may produce a 2D image. As an example, a receiver array or receiver arrays may be deployed at a range of depths in a borehole. As an example, offset increases can increase volume of subsurface imaged and can map reflectors at a distance from a borehole, for example, that may be related to offset and subsurface velocities. As an example, added volume of “illumination” may enhance usefulness of an image, for example, for correlation with one or more surface seismic images and, for example, for identification of faulting and dip laterally away from a borehole. As an example, as the conversion of P-waves to S-waves increases with offset, an offset VSP technique may allow for one or more of shearwave, amplitude variation with offset (AVO) and anisotropy analyses. As an example, degree to which P-waves convert to S-waves may depend on offset and on interface rock properties.

As to a walkaway VSP, a source may be offset from vertical incidence, however, a borehole receiver array may remain stationary, for example, while a source moves away from it, or “walks away,” for example, over a range of offsets. In such an example, a range of offsets acquired in a walkaway VSP may be useful for analysis of one or more of shear-wave, AVO and anisotropy effects.

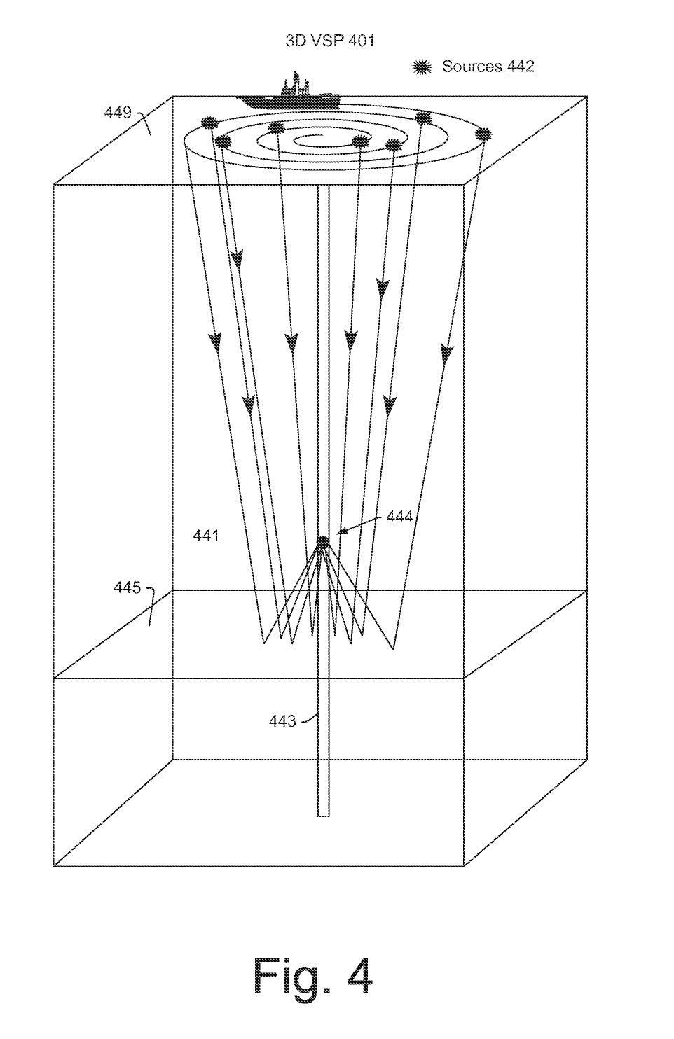

The example techniques 301, 302, 303 and 304 of FIG. 3 may be applied, for example, to provide information and/or images in one or two dimensions (e.g., or optionally three-dimensions, depending on implementation). As to three-dimensional VSPs, FIG. 4 shows an example of a technique 401 with respect to a geologic environment 441, a surface 449, at least one energy source (e.g., a transmitter) 442 that may emit energy where the energy travels as waves that interact with the geologic environment 441. As an example, the geologic environment 441 may include a bore 443 where one or more sensors (e.g., receivers) 444 may be positioned in the bore 443. As an example, energy emitted by the energy source 442 may interact with a layer (e.g., a structure, an interface, etc.) 445 in the geologic environment 441 such that a portion of the energy is reflected, which may then be sensed by at least one of the one or more of the sensors 444.

As an example, a 3D VSP technique may be implemented with respect to an onshore and/or an offshore environment. As an example, an acquisition technique for an onshore (e.g., land-based) survey may include positioning a source or sources along a line or lines of a grid; whereas, in an offshore implementation, source positions may be laid out in lines or in a spiral centered near a well.

A 3D acquisition technique may help to illuminate one or more 3D structures (e.g., one or more features in a geologic environment). Information acquired from a 3D VSP may assist with exploration and development, pre job modeling and planning, etc. As an example, a 3D VSP may fill in one or more regions that lack surface seismic survey information, for example, due to interfering surface infrastructure or difficult subsurface conditions, such as, for example, shallow gas, which may disrupt propagation of P-waves (e.g., seismic energy traveling through fluid may exhibit signal characteristics that differ from those of seismic energy traveling through rock).

As an example, a VSP may find use to tie time-based surface seismic images to one or more depth-based well logs. For example, in an exploration area, a nearest well may be quite distant such that a VSP is not available for calibration before drilling begins on a new well. Without accurate time-depth correlation, depth estimates derived from surface seismic images may include some uncertainties, which may, for example, add risk and cost (e.g., as to contingency planning for drilling programs). As an example, a so-called intermediate VSP may be performed, for example, to help develop a time-depth correlation. For example, an intermediate VSP may include running a wireline VSP before reaching a total depth. Such a survey may, for example, provide for a relatively reliable time-depth conversion; however, it may also add cost and inefficiency to a drilling operation and, for example, it may come too late to forecast drilling trouble. As an example, a seismic while drilling process may be implemented, for example, to help reduce uncertainty in time-depth correlation without having to stop a drilling process. Such an approach may provide real-time seismic waveforms that can allow an operator to look ahead of a drill bit, for example, to help guide a drill string to a target total depth.

As an example, a data acquisition technique may be implemented to help understand a fracture, fractures, a fracture network, etc. As an example, a fracture may be a natural fracture, a hydraulic fracture, a fracture stemming from production, etc. As an example, seismic data may help to characterize direction and magnitude of anisotropy that may arise from aligned natural fractures. As an example, a survey may include use of offset source locations that may span, for example, a circular arc to probe a formation (e.g., from a wide range of azimuths). As an example, a hydraulically induced fracture or fractures may be monitored using one or more borehole seismic methods. For example, while a fracture is being created in a treatment well, a multicomponent receiver array in a monitor well may be used to record microseismic activity generated by a fracturing process.

Seismic surveys may be acquired at different stages in the life of a reservoir. As an example, one or more of offset VSPs, walkaway VSPs, 3D VSPs, etc. may be acquired in time-lapse fashion, for example, before and after production. Time-lapse surveys may reveal changes in position of fluid contacts, changes in fluid content, and other variations, such as pore pressure, stress and temperature. VSP techniques may be seen as evolving, for example, from being a time-depth tie for surface seismic data to being capable of encompassing a range of solutions to various types of questions germane to exploration, production, etc.

As mentioned, an output from a zero-offset VSP may be one or more corridor stacks. In the examples of FIGS. 1, 2, 3 and 4, receivers (e.g., geophones) are shown as being located below a surface or surfaces. As such, they may respond to both downgoing and upgoing energy, which may allow insight into properties of propagating wavelets and reflective/transmissive earth processes. As an example, a method may include vertical stacking (e.g., corridor stacking) to improve signal-to-noise (S/N) ratio and, for example, to discriminate against multiples, for example, by multiples suppression (e.g., multiples attenuation). As an example, for the signals 262 illustrated in FIG. 2, multiples suppression may act to diminish the influence of signals from the interbed multiple reflections 250 with respect to other signals, which, in turn, may improve analyses as to one or more characteristics of a layer, an interface, etc. in a geologic environment.

As an example, VSP processing may create wavefields that may be expressed in terms of different time coordinates, or time frames. VSP survey arrival times for downgoing arrivals tends to increase with respect to receiver depth while upgoing reflection times from a subsurface horizon tend to decrease with respect to increasing receiver depth (e.g., where a receiver is closer to a reflector). Thus, slopes for arrival times of downgoing and upgoing arrivals can have different signs.

As to VSP data processing, as an example, in field record time (FRT), downgoing compressional events have opposite time-dip from upgoing events. For example, consider TT to be a first-arrival traveltime for downgoing arrivals. In such an example, a time frame advanced by first-arrival time by subtracting time TT, would flatten a downgoing wave and steepen a slope of upgoing events, for example, possibly causing aliasing of upgoing energy. As an example, a time frame delayed by first-arrival time (CTT) may flatten upgoing events for zero source-to-receiver lateral offset and, for example, horizontal reflectors. As an example, a time shift may effectively place an upgoing compressional event in a two-way time frame, for example, comparable with common midpoint (CMP) data.

As an example, corridor stacking may be performed in a CTT time frame. In such a domain, corridor stacking may involve summation of upgoing reflection energy along a line, for example, a line of constant time. Such VSP processing may involve separation of upgoing wavefileds and downgoing wavefields. For example, during processing, first-arrival times may be subtracted from a downgoing wavefield in a CTT time frame (e.g., CTT domain). In such an example, application of f-k filtering (e.g. frequency-wavenumber filtering) may separate out an upgoing reflected wavefield and leave a downgoing wavefield. As an example, median filtering may be applied to enhance signal-to-noise ratio. As an example, waveshaping a downgoing wavelet may produce a deconvolved downgoing wavefield.

As an example, processing may be applied to an upgoing wavefield, for example, in a domain where first-arrival times have been added. For a processed upgoing reflection wavefield, there may be some reflection events that are relatively strong across an array of VSP traces, which may correspond to primary reflections. However, there may be deeper events that are weaker for so-called “outside corridor” traces (e.g., events that are earlier in time for a given trace depth). As an example, an outside corridor region of earlier arrival times at given receiver depths may be referred to as a “front” or a “short” part of VSP data. As an example, an outside corridor may be in an early mute zone of the data; whereas, an “inside corridor” region of later arrivals for given trace depths may be referred to as a “back” or a “long” part of the VSP data. As an example, corridor stacking may be applied to an upgoing wavefield section to enhance reflections in various zones.

As an example, corridor stacking of VSP gathers may be applied to an upgoing wavefield. For a zero-offset source, horizontal layers without structure, and a non-deviated borehole, upgoing events may be aligned in the CTT time frame, for example, along lines of constant time. As in CMP stacking, the addition of traces with coherent energy in phase may cause the signal level of that energy to be increased over random noise by the square root of the number of input traces. Such a result may be achieved by stacking upgoing VSP energy, however, an overall result may be output, for example, to make distinctions between primary and multiple events.

As an example, corridor stacking may be applied for two regions of VSP data, which may be termed “outside” and “inside” regions. As multiples may be delayed in time relative to interbed interface primary reflections (see, e.g., FIG. 2), stacking within a time window delayed (e.g., slightly delayed) from a first break trajectory may represent primaries as well as, for example, interbed multiples with periods less than or equal to a time window length. Such a stack may be referred to as an outside corridor stack. An outside corridor stack may be expected to be dominated by primaries (e.g., primary reflections). As an example, stacking of arrivals that appear later in time may form a stack that is referred to as an inside corridor stack. An inside corridor stack may be expected to show the presence of interbed multiples (e.g., depending on characteristics of a geologic environment). Thus, a method that processes VSP data to form an outside corridor stack and to form an inside corridor stack may further include analyzing the outside corridor stack for primaries and analyzing the inside corridor stack for multiples. In other words, by forming two different types of corridor stacks, VSP data may yield information that can help to make distinctions between primary and multiple events.

As an example, a full VSP stack may include a totality of upgoing energy, for example, such that longer period multiple effects may be identified. A method may include making a regional division, for example, between inside and outside stacks, to aid in discriminating between primaries and multiples.

As an example, a method may include using one or more outside corridor stacks that include various mute zones and comparing the one or more corridor stacks to a full corridor stack, for example, rather than to an inside corridor stack. Noting, however, as an example, a full corridor stack may be a limiting case of the largest inside corridor stack.

As an example, in a plot of a VSP wavefield (e.g., associated with a survey region), outside and inside corridors may be identified using lines, for example, a line or lines running parallel to a mute zone may be used to identify an outside corridor while a line or lines running vertically may be used to identify an inside corridor.

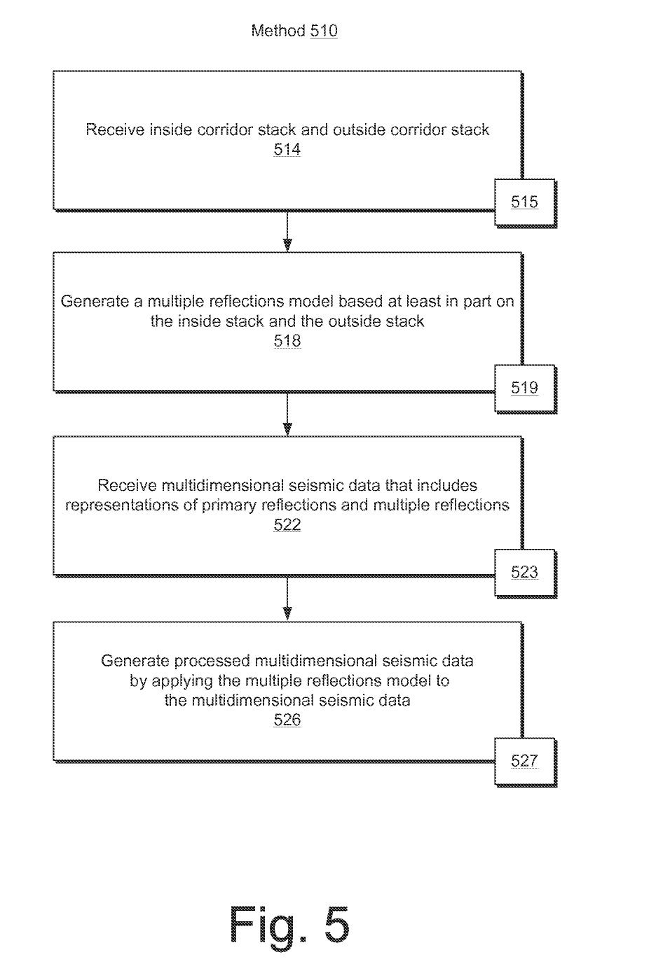

FIG. 5 shows an example of a method 510 that includes a reception block 514 for receiving an inside stack and an outside stack, a generation block 518 for generating a multiple reflections model based at least in part on the inside stack and the outside stack, a reception block 522 for receiving multidimensional seismic data that includes representations of primary reflections and multiple reflections and a generation block 526 for generating processed multidimensional seismic data by applying the multiple reflections model to the multidimensional seismic data. In such an example, the multiple reflections model may be a one-dimensional multiple reflections model.

The method 510 may be associated with various computer-readable media (CRM) blocks or modules 515, 519, 523 and 527. Such blocks or modules may include instructions suitable for execution by one or more processors (or processor cores) to instruct a computing device or system to perform one or more actions. As an example, a single medium may be configured with instructions to allow for, at least in part, performance of various actions of the method 510. As an example, a computer-readable medium (CRM) may be a computer-readable storage medium (e.g., a non-transitory medium).

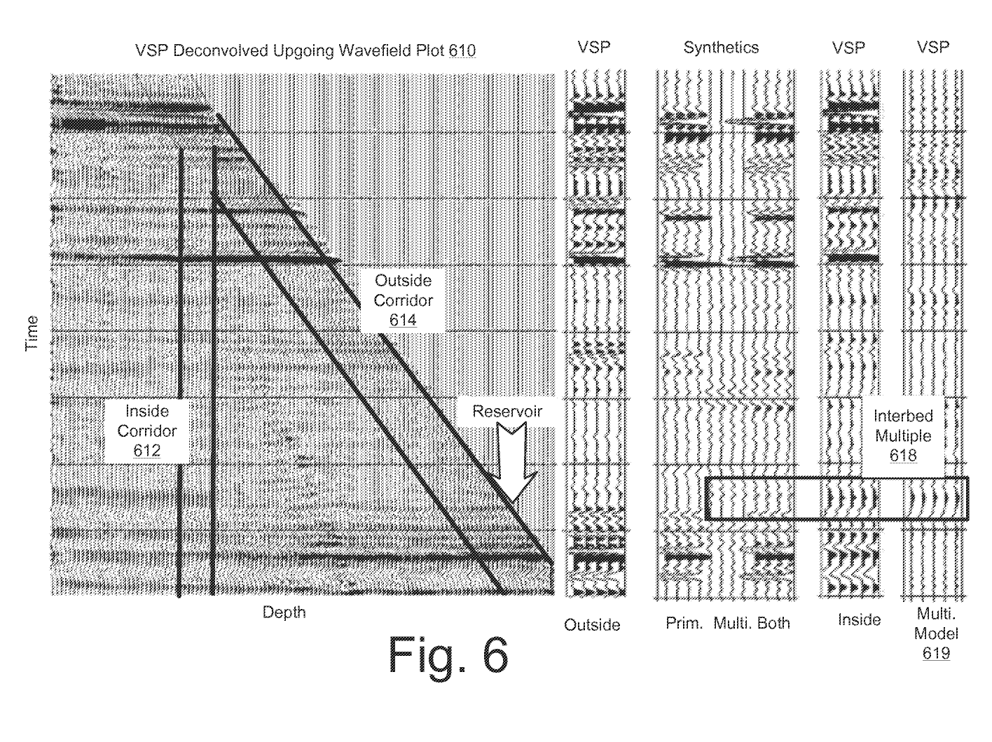

FIG. 6 shows an example plot 610 of VSP data and processed data where an inside corridor 612 and an outside corridor 614 are identified as well as an interbed multiple 618. The plot 610 shows deconvolved upgoing waves from a near-offset shot with lines that identified the inside corridor 612 and the outside corridor 614 and a border of a box approximates the time location of the identified interbed multiple 618.

The plot 610 of FIG. 6 corresponds to a shot performed near a wellhead that may be viewed as being a standard zero-offset VSP (ZVSP). In this example, inside and outside corridor stacks of the deconvolved ZVSP data were obtained by data processing. As shown in FIG. 6, an outside corridor stack may include representations of primaries and may be relatively free of representations of multiples, for example, along a receiver array and an inside corridor stack may include representations of interbed multiples and may include representations of primaries as well.

The interbed multiple 618 can be seen on the inside corridor stack as associated with a time span (e.g., of the order of about 0.1 s, about 100 ms). As to depth, the interbed multiple 618 is shown as being close to a top of a reservoir (e.g., located at about 2 km in depth). Such a multiple may interfere with a desired target reflection (e.g., data associated with a primary reflection of the top of the reservoir). As an example, an inside corridor may be targeted to examine multiples generated by high reflectivity interfaces. As an example, a method may include generating interbed, or peg-leg, multiples from the reflectivity estimated from a compressional sonic log (e.g., to locate multiples in seismic sections).

As an example, a method may include using synthetics (see, e.g., FIG. 6). As an example, synthetics may be used to help confirm one or more multiples detected by an inside/outside corridor stack processing technique. For example, referring to FIG. 6, the interbed multiple 618 may be confirmed via a multiple synthetic (e.g., via a model for synthetic generation of multiple reflection data) and, for example, a primary-plus-multiple synthetic (e.g., via a model for synthetic generation of primary reflection and multiple reflection data). As an example, a method may include applying adaptive subtraction to inside and outside corridor stacks, for example, to estimate an internal multiple model for a portion of a field (e.g., consider a region in a field that may include a well and that extends a distance from the well). In FIG. 6, representations 619 generated by a multiple model are shown in a rightmost stack. As an example, a method may include estimating an internal multiple model (e.g., using a one-dimensional approximation) and adaptively subtract internal multiples from a multidimensional VSP data (e.g., a 3D VSP image cube).

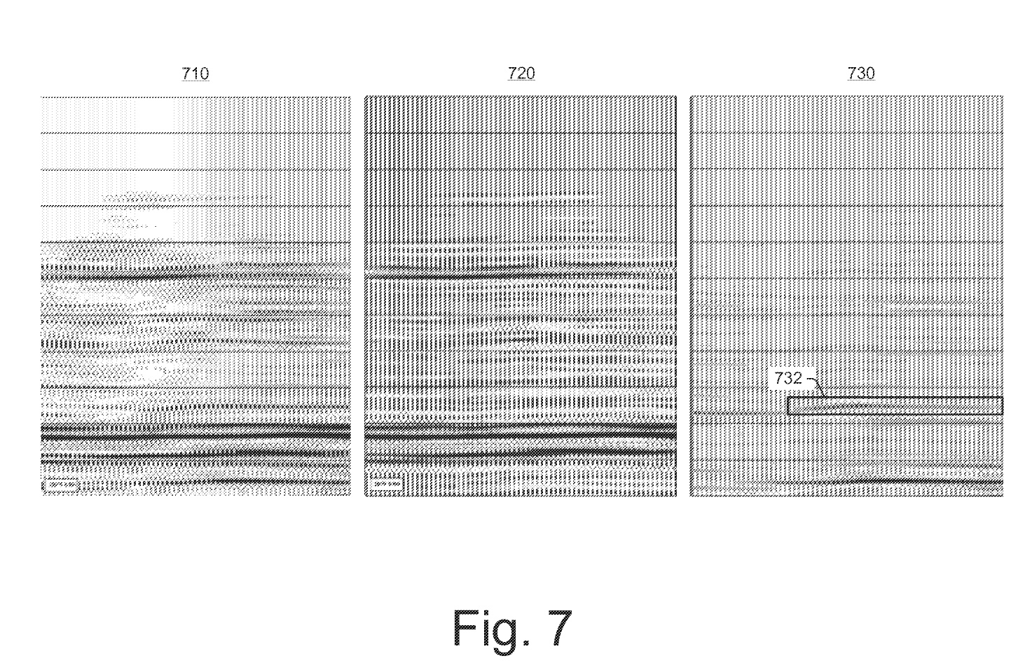

FIG. 7 shows an example of results from a method that includes processing of data. In particular, FIG. 7 shows a migrated P-wave image 710, the migrated P-wave image 720 after applying a method that includes attenuating one or more multiples and an image that includes representations of one or more multiples 730, including a multiple 732 that has been attenuated (e.g., compare 710, 720 and 730 as to the location of the multiple 732).

As an example, a method may include VSP multiples attenuating (e.g., attenuation of data that represents energy associated with multiple reflections). As shown in the example of FIG. 6 and FIG. 7, a method may be applied to attenuate interbed multiple data that may, for example, interfere with desired data. For example, where primary data for a target structure is of interest and where the primary data may be obscured in part by multiple data, a method may be applied to identify one or more multiples in the multiples data and to attenuate the multiples data, for example, to allow for processing of primary data. As shown in the example of FIGS. 6 and 7, identification of and attenuation of the interbed multiple 618 may allow for processing of data germane to a structure such as a top of a reservoir, which may be more readily identified (e.g., and located) via primaries data.

As an example, inside and outside stacks of a zero-offset VSP (ZVSP) survey (e.g., or optionally surface seismic image gathers) may be used to estimate a multiple model. As an example, such a multiple model may be used to attenuate multiples on seismic images (e.g., or optionally image gathers).

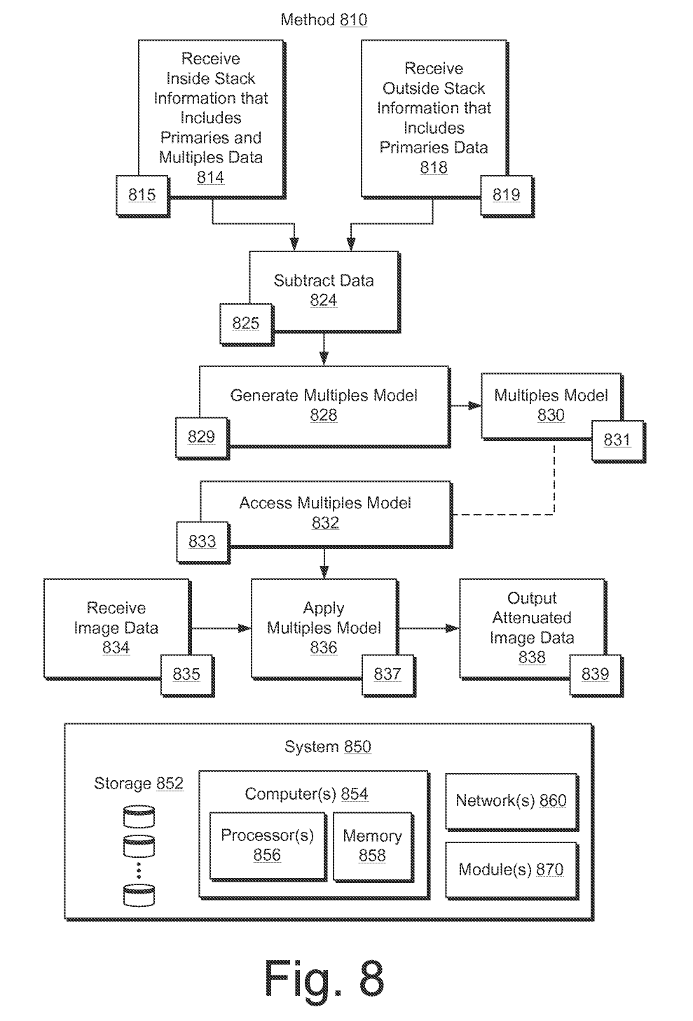

FIG. 8 shows an example of a method 810 and an example of a system 850. As shown in FIG. 8, the system 850 may include one or more information storage devices 852, one or more computers 854, one or more network interfaces 860 and one or more modules 870. As to the one or more computers 854, each computer may include one or more processors (e.g., or processing cores) 856 and memory 858 for storing instructions (e.g., modules), for example, executable by at least one of the one or more processors 856. As an example, a computer may include one or more network interfaces (e.g., wired or wireless), one or more graphics cards, a display interface (e.g., wired or wireless), etc. As an example, the system 850 may be configured to perform a method such as the method 810.

The method 810 includes a reception block 814 for receiving inside stack information that includes primaries and multiples data and a reception block 818 for receiving outside stack information that includes primaries data. As an example, the system 850 may include the one or more information storage devices 852 that store information and/or the one or more network interfaces 870 that may be operatively coupled to one or more information storage devices that store information (e.g., the one or more information storage devices 852 or one or more other information storage devices). For example, the system 850 may access and receive stored information via an interface, which may be a network interface or other type of interface. As an example, information, such as stack information, may be provided as stored information (e.g., stored in one or more information storage devices). As an example, information may be received by a processor or processors, for example, via an internal bus and/or via an external bus of a computing device (e.g., a computer, a server, etc.). As an example, a network interface may be part of an external bus, which may be, at least in part, for example, wired and/or wireless.

As an example, a method may include receiving information that may be processed to form inside stack information and outside stack information (e.g., via deconvolution, etc.). In such an example, the received information may be considered as including inside stack information and outside stack information. As an example, a method may include receiving information via data acquisition equipment, optionally in near real-time. In such an example, the information may be processed and, for example, optionally used to adjust one or more parameters associated with data acquisition (e.g., receiver location, source location, source energy, source frequency, gain, filtering, etc.).

As shown in FIG. 8, the method 810 includes a subtraction block 824 for subtracting data. For example, the primaries and multiples data of the inside stack information may be subtracted from the primaries data of the outside stack information or vice versa. As an example, subtracting may include adaptively subtracting data.

As an example, adaptive subtraction may include using an equation such as the following equation:

$${x}_{o} = p + {\sum }_{i = 1}^{N} {h}_{i} * {x}_{i}$$

where xₒ is a set of discrete signals, where p and hᵢ may be, initially, unknowns and where * denotes convolution. In such an example, p may represent primaries where xₒ includes both primaries and multiples. As to such parameters, for example, consider use of outside stack information that includes primaries data and inside stack information that includes primaries and multiples data, respectively.

As an example, the presence of hᵢ to h_{N} may be due to imperfections of a multiple prediction algorithm and be interpreted as uncertainties for amplitude scaling, phases, time delay, acquisition wavelets and other factors. In such an example, other sets of discrete signals (e.g., x₁ to x_{N}) may be used to represent a variety of multiple predictions (e.g., various degrees of interbed multiple predictions, different multiple prediction traces, etc.).

As an example, casting data in the form of the foregoing equation may allow for adaptive subtraction, for example, to subtract primaries data from primaries and multiples data to arrive at multiples data. In such an example, the multiples data may be, for example, further processed, etc.

In the method 810 of FIG. 8, data stemming from the subtraction block 824 may be provided to a generation block 828 for generating a multiples model 830, for example, a model that can represent a multiply reflected wave or multiply reflected waves.

As an example, a multiples model may be a one-dimensional multiples model. As an example, a one-dimensional multiples model may be implemented using a system that may provide for processing of input information in near real-time. For example, such a model may allow for adjusting one or more parameters associated with a field operation (e.g., a seismic survey or other operation) in near real-time (e.g., during the seismic survey, etc.).

As an example, a multiples model may be based on, or include, one or more equations. As an example, consider the following equation:

$$[ \begin{matrix}{U}_{k} \\ {D}_{k}\end{matrix} ] = {E}_{k} ( f ) {T}_{k - 1} [ \begin{matrix}{U}_{k - 1} \\ {D}_{k - 1}\end{matrix} ] = {G}_{k}^{k - 1} [ \begin{matrix}{U}_{k - 1} \\ {D}_{k - 1}\end{matrix} ]$$

$${E}_{k} ( f ) = [ \begin{matrix}exp ( \frac{i2π f Δ {z}_{k}}{{c}_{k}} ) & 0 \\ 0 & exp ( \frac{- i2π f Δ {z}_{k}}{{c}_{k}} )\end{matrix} ]$$

$${T}_{k - 1} = \frac{1}{1 - {r}_{k - 1}} [ \begin{matrix}1 & - {r}_{k - 1} \\ - {r}_{k - 1} & 1\end{matrix} ]$$

The foregoing equation may be used to form a one-dimensional model of a geologic environment, for example, that may include layers (e.g., horizontal layers with respective surfaces). In such an example, pressure potentials for vertically propagating acoustic waves (e.g., upgoing U and downgoing D) at a depth level (e.g., just above zₖ) may be related to potentials at a shallower depth level (e.g., slightly above zₖ₋₁). As an example, appropriate boundary conditions may be applied to arrive at a one-dimensional model for multiples (e.g., a one-dimensional multiple reflections model).

Referring again to the method 810 of FIG. 8, as shown, a multiples model may be output by the generation block 828 as illustrated by the multiples model block 830. Such a model may be used in an attenuation process that acts to attenuate multiples data. For example, a reception block 834 can include receiving image data (e.g., as input), an access block 832 can include accessing the multiples model 830, an attenuation block 836 can include attenuating at least a portion of multiples data in the image data using the multiples model 830 and an output block 838 can include outputting multiples attenuated image data. In such an example, attenuating may include adaptively subtracting multiples from image data (e.g., or image gathers), for example, using a multiples model (e.g., data generated by a multiples model).

As an example of input and output for a method, consider the image data 710, 720 and 730 of FIG. 7. With respect to the method 810 of FIG. 8, the image data 710 may be received via the reception block 834, be subject to attenuation via the attenuation block 836 and the image data 720 may be output via the output block 838. As an example, data may be output by storing to a storage device, output by rendering to a display, output by printing to a printer, etc. As an example, the reception block 834, the attenuation block 836 and the output block 838 may be implemented as part of a workflow. As an example, the blocks 814, 818, 824 and 828 may be implemented as part of a workflow. As an example, a workflow may include implementing the blocks 814, 818, 824 and 828 and then the blocks 832, 834, 836 and 838. As an example, the blocks 834, 836 and 838 may be repeated, for example, for different images, image portions, etc. As an example, a workflow may include adjusting one or more parameters of survey, optionally during the survey, for example, based at least in part on an attenuation process that attenuates multiples data.

The method 810 may be associated with various computer-readable media (CRM) blocks or modules 815, 819, 825, 829, 831, 833, 835, 837 and 839. Such blocks or modules may include instructions suitable for execution by one or more processors (or processor cores) to instruct a computing device or system to perform one or more actions. As an example, a single medium or module may be configured with instructions to allow for, at least in part, performance of various actions of the method 810. As an example, a computer-readable medium (CRM) may be a computer-readable storage medium (e.g., a non-transitory medium).

As shown in FIG. 8, the system 850 can include the one or more processors 856; the memory 858 (e.g., accessible by at least one of the one or more processors 856); the one or more modules 870 (e.g., stored in the memory 858) where the one or more modules 870 include processor-executable instructions to instruct the system 850 to: access a multiple reflections model (see, e.g., the module 833); receive multidimensional seismic data that represents primary reflections and multiple reflections (see, e.g., the module 835); and apply the multiple reflections model to at least a portion of the multidimensional seismic data to attenuate the multidimensional seismic data that represents the multiple reflections (see, e.g., the module 837). As an example, in the system 850, the one or more modules 870 may include processor-executable instructions to instruct the system 850 to output multiples attenuated data (see, e.g., the module 839). As an example, a multiple reflections model may be a one-dimensional multiple reflections model.

As described with respect to the method 810 of FIG. 8, outside and inside stacks of data may yield different information that may allow estimation of a multiple model.

As an example, for ZVSP survey data, data later than about 100 ms or less after a transit time or a first break arrival may be muted and the muted traces may be stacked to generate an outside stack trace. In such an example, the complement of an outside stack may be an inside stack. As an example, an outside stack up to a deepest receiver two-way time may yield a trace that is composed of primary reflections (e.g., dominated by primary reflections). As an example, an inside stack may yield a trace that is composed of both primary and multiple reflections.

As explained with respect to the method 810 of FIG. 8, by adaptively subtracting an outside stack from an inside stack, a method can include estimating a one-dimensional multiple model, for example, at a bore location (e.g., a well location, etc.). Further, an estimated multiples model may be used, for example, to adaptively subtract multiples from an image (e.g., or image gathers). Referring to FIG. 7, the image 720 is a multiples attenuated image as output via application of a ZVSP survey estimated multiples model. In particular, the input image 710 is based on multidimensional data associated with a three-dimensional VSP survey and, thus, the output image 720 is a multiples attenuated image that is based on multidimensional data. Thus, a one-dimensional multiples model may be applied to multidimensional data to, for example, attenuate multiples data therein. Such an approach may provide for outputting one or more images such that one or more structures may be more readily identified, for example, due to attenuation of data associated with multiply reflected waves.

As an example, for surface seismic image gathers, an outside stack may be defined as a stack of data from mid-to-far offset image traces and, for example, an inside stack may be defined as a stack of near-offset image traces. In such an example, an outside stack and an inside stack may include an overlapping portion of data or may avoid overlap of data. As an example, an offset value may be selected, for example, to define a demarcating boundary, in a case-dependent manner.

As an example, for image gathers, a method may include receiving inside and outside stacks and estimating a spatially varying multiple model. In such an example, differences between the two stacks may allow for estimation of a multiple model at one or more locations (e.g., image locations). As an example, a multiples model, which may be a one-dimensional model, may be used to adaptively subtract multiples from an image or from image gathers.

As an example, a method may include analyzing data for interbed multiples, for example, analyzing reflectivity estimated from a compressional sonic log. Such a method may include locating multiples in one or more seismic sections. As an example, a method may include analyzing data for peg-leg multiples. As an example, a peg-leg multiple may be a type of short-path multiple, or multiply-reflected seismic energy, that includes an asymmetric path. As an example, a short-path multiple may be added to a primary reflection. As an example a short-path multiple may be associated with shallow subsurface phenomena (e.g., also consider cyclical deposition). As an example, a period of a peg-leg multiple may be brief and interfere with a primary reflection in a manner that its interference diminishes high frequencies in a wavelet.

As an example, a method may include using a model to generate one or more synthetics. As an example, a synthetic may be a model generated signal, data, waveform, etc. As an example, a synthetic may be generated using a one-dimensional model that models acoustic energy traveling through one or more layers of material.

As an example, a method may include using synthetics to confirm multiples detected via inside/outside corridor stack data processing. For example, a multiple of interest may be confirmed on a multiple synthetic and a primary-plus-multiple synthetic. As an example, from inside and outside corridor stacks, a method may implement adaptive subtraction to estimate an internal multiple model for a region (e.g., a region proximate to a wellbore, such as a VSP survey region). As mentioned, the example representations 619 of FIG. 6 are generated via a multiple model (e.g., modeled representations, modeled multiples, synthetic multiples, etc.). As an example, after estimating internal multiples (e.g., via a model that may include a 1D assumption), a method may include adaptively subtracting internal multiples from a 3D VSP image cube. As mentioned, FIG. 7 shows results from a method that includes attenuating an interbed multiple interfering with a portion of data associated with a feature such as, for example, a reservoir. As an example, a method may include receiving information associated with corridor stacks and implementing an adaptive technique (e.g., adaptive subtraction) to attenuate one or more interbed multiples from image data (e.g., from an image, image volume, etc.).

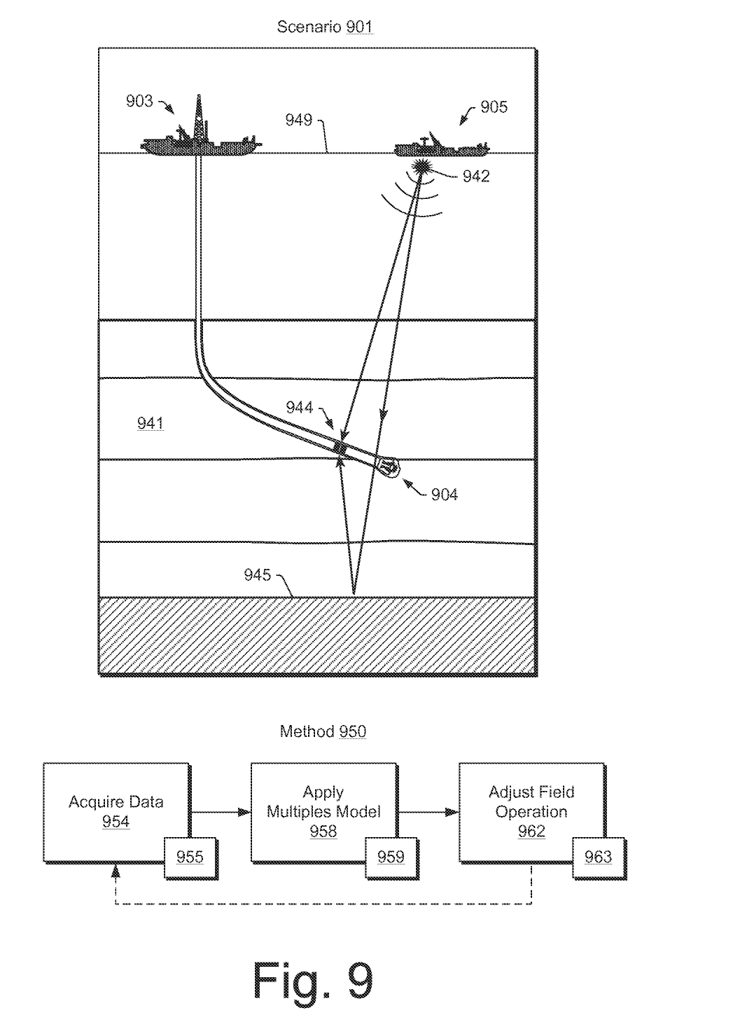

As an example, a method may include receiving data, for example, as acquired using one or more survey techniques such as, for example, one or more of the survey techniques of FIG. 3 and/or FIG. 4. As an example, data may include data acquired using a seismic-while-drilling (SWD) technique. For example, FIG. 9 shows a scenario 901 where drilling equipment 903 operates a drill bit 904 operatively coupled to an equipment string that includes one or more sensors (e.g., one or more receivers) 944. In the scenario 901, the drill bit 904 is advanced in a geologic environment 941 that includes stratified layers disposed below a sea bed surface where the layers include a layer 945. As shown in the example of FIG. 9, at a water surface 949 of the geologic environment 941, seismic equipment 905 includes a seismic energy source 942 that can emit seismic energy into the geologic environment 941.

As an example, energy may be reflected in the geologic environment 941 as an upgoing primary wave (e.g., or “primary” or “singly” reflected wave) and, for example, where a portion of emitted energy may be reflected by more than one structure in the geologic environment and referred to as a multiple reflected wave (see, e.g., FIG. 2). As an example, data acquired using one or more techniques may be processed, for example, to attenuate one or more multiples.

As an example, the seismic equipment 905 may be moveable, duplicated, etc., for example, to emit seismic energy from various positions, which may be positions about a region of the geologic environment 941 that includes the drill bit 904. As an example, the scenario 901 may be a VSP scenario, for example, where the equipment 903, 944, 905 and 942 can perform a seismic survey (e.g., a VSP while drilling survey).

As an example, a survey may take place during one or more so-called “quiet” periods during which drilling is paused. As an example, data acquired via a survey may be analyzed where results from an analysis or analyses may be used, at least in part, to direct further drilling, make assessments as to a drilled portion of a geologic environment, etc. As an example, a method may optionally include processing in near real-time, which may, for example, be instructive for seismic while drilling, etc.

As an example, a technique may include microseismology. For example, consider a bore that may be an injection bore for injecting fluid, particles, chemicals, etc. germane to fracturing (e.g., a fracturing operation). As an example, fluid may include water, particles may include proppant and chemicals may include surfactant where pressurized water may act to create a fracture, proppant may act to maintain the fracture and surfactant may act to reduce surface tension to promote fluid flow via the fracture, for example, to promote flow of reservoir fluid (e.g., fluid that may include one or more hydrocarbons, etc.). In such an example, fracturing may be considered a seismic energy source in a geologic environment where one or more sensors may be receive the energy, for example, as reflected by structures in the geologic environment. As an example, survey may be established using seismic energy emitted by fracturing. In such an example, data acquired thereby may be analyzed, for example, as to reflections (e.g., primaries and multiples). In turn, one or more field operations may be adjusted based at least in part on an analysis or analyses (e.g., as to drilling, further fracturing, etc.).

In FIG. 9, the method 950 includes an acquisition block 954 for acquiring data, an application block 958 for applying a multiples model and an adjustment block 962 for adjusting one or more field operations, for example, based at least in part on an output from applying a multiples model.

The method 950 may be associated with various computer-readable media (CRM) blocks or modules 953, 957 and 963. Such blocks or modules may include instructions suitable for execution by one or more processors (or processor cores) to instruct a computing device or system to perform one or more actions. As an example, a single medium may be configured with instructions to allow for, at least in part, performance of various actions of the method 950. As an example, a computer-readable medium (CRM) may be a computer-readable storage medium (e.g., a non-transitory medium).

As an example, a method may include acquiring data where the data includes VSP survey data and optionally other data, for example, from drilling, a microseismic survey, etc. As an example, a method may include acquiring data where the data include seismic while drilling data. As an example, a method may include adjusting a field operation such as, for example, a treatment operation (e.g., to generate a fracture via injection, etc.), a drilling operation, etc., where the adjusting occurs in response to output from applying a multiples model to seismic data (e.g., multidimensional seismic data).

As an example, a method can include receiving an inside stack and an outside stack; generating a multiple reflections model based at least in part on the inside stack and the outside stack; receiving multidimensional seismic data that includes representations of primary reflections and multiple reflections; and generating processed multidimensional seismic data by applying the multiple reflections model to the multidimensional seismic data. In such an example, the multiple reflections model may be a one-dimensional multiple reflections model.

As an example, an inside stack may include representations of primary reflections and multiple reflections and an outside stack may include representations of multiple reflections. As an example, a method may include generating a multiple reflections model at least in part by adaptively subtracting an outside stack from an inside stack.

As an example, a method may include applying a multiple reflections model at least in part by adaptively subtracting at least a portion of representations of multiple reflections from at least a portion of multidimensional seismic data.

As an example, a method may include deconvolving seismic data to generate an inside stack and an outside stack. As an example, seismic data may be or include vertical seismic profile (VSP) data. As an example, seismic data may be or include zero-offset vertical seismic profile (ZVSP) data.

As an example, a method may include generating an inside stack and an outside stack from surface seismic data. For example, such generating may generate the inside stack using near-offset surface seismic image traces and generate the outside stack using mid-to-far offset surface seismic image traces.

As an example, a method may include identifying representations of an interbed boundary in processed multidimensional seismic data. In such an example, the interbed boundary may correspond to a boundary of a reservoir.

As an example, a system can include a processor; memory accessible by the processor; one or more modules stored in the memory and that include processor-executable instructions to instruct the system to: access a multiple reflections model; receive multidimensional seismic data that represents primary reflections and multiple reflections; and apply the multiple reflections model to at least a portion of the multidimensional seismic data to attenuate the multidimensional seismic data that represents the multiple reflections. In such an example, the multiple reflections model may be a one-dimensional multiple reflections model.

As an example, a system may include one or more modules stored in the memory that include processor-executable instructions to instruct the system to: receive an inside stack and an outside stack; and generate a multiple reflections model based at least in part on the inside stack and the outside stack. In such an example, the system may include one or more modules stored in the memory that include processor-executable instructions to instruct the system to: receive seismic data; deconvolve the seismic data; and generate the inside stack and the outside stack (e.g., based at least in part on deconvolution of the seismic data).

As an example, a system may include one or more modules stored in the memory that include processor-executable instructions to instruct the system to adjust one or more parameters of a field operation (e.g., via equipment in a field, above a field, etc.).

As an example, one or more computer-readable storage media can include computer-executable instructions to instruct a system to: access a multiple reflections model; receive multidimensional seismic data that represents primary reflections and multiple reflections; and apply the multiple reflections model to at least a portion of the multidimensional seismic data to attenuate the multidimensional seismic data that represents the multiple reflections. As an example, the multiple reflections model may be a one-dimensional multiple reflections model.

As an example, one or more computer-readable storage media may include computer-executable instructions to instruct a system to: receive an inside stack and an outside stack; and generate a multiple reflections model based at least in part on the inside stack and the outside stack. As an example, the multiple reflections model may be a one-dimensional multiple reflections model.

As an example, one or more computer-readable storage media may include computer-executable instructions to instruct a system to: receive seismic data; and deconvolve the seismic data to generate an inside stack and an outside stack (e.g., based at least in part on deconvolution of the seismic data).

As an example, a system may include one or more modules, which may be provided to analyze data, control a process, perform a task, perform a workstep, perform a workflow, etc.

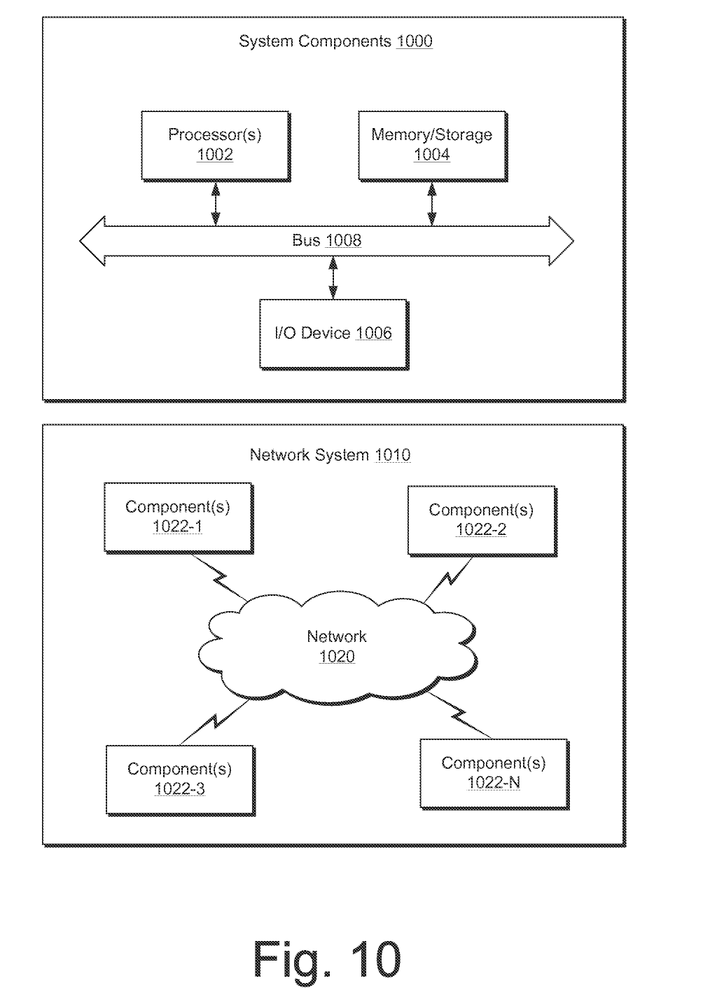

FIG. 10 shows components of an example of a computing system 1000 and an example of a networked system 1010. The system 1000 includes one or more processors 1002, memory and/or storage components 1004, one or more input and/or output devices 1006 and a bus 1008. In an example embodiment, instructions may be stored in one or more computer-readable media (e.g., memory/storage components 1004). Such instructions may be read by one or more processors (e.g., the processor(s) 1002) via a communication bus (e.g., the bus 1008), which may be wired or wireless. The one or more processors may execute such instructions to implement (wholly or in part) one or more attributes (e.g., as part of a method). A user may view output from and interact with a process via an I/O device (e.g., the device 1006). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1010. The network system 1010 includes components 1022-1, 1022-2, 1022-3, . . . 1022-N. For example, the components 1022-1 may include the processor(s) 1002 while the component(s) 1022-3 may include memory accessible by the processor(s) 1002. Further, the component(s) 1002-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH®, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. A method comprising:
receiving an inside stack and an outside stack;
generating a multiple reflections model based at least in part on the inside stack and the outside stack;
receiving multidimensional seismic data that comprises representations of primary reflections and multiple reflections; and
generating processed multidimensional seismic data by applying the multiple reflections model to the multidimensional seismic data.

2. The method of claim 1, wherein the multiple reflections model comprises a one-dimensional multiple reflections model.

3. The method of claim 1, wherein the inside stack comprises representations of primary reflections and multiple reflections and wherein the outside stack comprises representations of multiple reflections.

4. The method of claim 3, wherein the generating the multiple reflections model comprises adaptively subtracting the outside stack from the inside stack.

5. The method of claim 1, wherein the applying the multiple reflections model comprises adaptively subtracting at least a portion of the representations of the multiple reflections from at least a portion of the multidimensional seismic data.

6. The method of claim 1, further comprising deconvolving seismic data to generate the inside stack and the outside stack.

7. The method of claim 6, wherein the seismic data comprises vertical seismic profile (VSP) data.

8. The method of claim 7, wherein the seismic data comprises zero-offset vertical seismic profile (ZVSP) data.

9. The method of claim 1, further comprising generating the inside stack and the outside stack from surface seismic data.

10. The method of claim 9, comprising generating the inside stack using near-offset surface seismic image traces and generating the outside stack using mid-to-far offset surface seismic image traces.

11. The method of claim 1, further comprising identifying representations of an interbed boundary in the processed multidimensional seismic data.

12. The method of claim 11, wherein the interbed boundary corresponds to a boundary of a reservoir.

13. A system comprising:
a processor;
memory accessible by the processor;
one or more modules stored in the memory and that comprise processor-executable instructions to instruct the system to:
access a multiple reflections model;
receive multidimensional seismic data that represents primary reflections and multiple reflections; and
apply the multiple reflections model to at least a portion of the multidimensional seismic data to attenuate the multidimensional seismic data that represents the multiple reflections.

14. The system of claim 13, wherein the multiple reflections model comprises a one-dimensional multiple reflections model.

15. The system of claim 13, further comprising one or more modules stored in the memory and that comprise processor-executable instructions to instruct the system to:
receive an inside stack and an outside stack; and
generate the multiple reflections model based at least in part on the inside stack and the outside stack.

16. The system of claim 15, further comprising one or more modules stored in the memory and that comprise processor-executable instructions to instruct the system to:
receive seismic data;
deconvolve the seismic data; and
generate the inside stack and the outside stack based at least in part on deconvolution of the seismic data.

17. The system of claim 13, further comprising one or more modules stored in the memory and that comprise processor-executable instructions to instruct the system to adjust one or more parameters of a field operation.

18. One or more computer-readable storage media comprising computer-executable instructions to instruct a system to:
access a multiple reflections model;
receive multidimensional seismic data that represents primary reflections and multiple reflections; and
apply the multiple reflections model to at least a portion of the multidimensional seismic data to attenuate the multidimensional seismic data that represents the multiple reflections.

19. The one or more computer-readable storage media of claim 18, comprising computer-executable instructions to instruct a system to:
receive an inside stack and an outside stack; and
generate the multiple reflections model based at least in part on the inside stack and the outside stack.

20. The one or more computer-readable storage media of claim 19, comprising computer-executable instructions to instruct a system to:
receive seismic data;
deconvolve the seismic data; and
generate the inside stack and the outside stack based at least in part on deconvolution of the seismic data.
